(19) United States
(12) Patent Application Publication
(10) Pub. No.: US 2019/0279573 A1
(43) Pub. Date: Sep. 12, 2019

(54) PIXEL CIRCUITS AND DRIVING METHODS THEREOF, DISPLAY DEVICES

(71) Applicant: KunShan Go-Visionox Opto-Electronics Co., Ltd., Kunshan (CN)

(72) Inventor: Zhiyi ZHOU, Kunshan (CN)

(73) Assignee: KunShan Go-Visionox Opto-Electronics Co., Ltd., Kunshan (CN)

(21) Appl. No.: 16/426,279

(22) Filed: May 30, 2019

Related U.S. Application Data
(63) Continuation of application No. PCT/CN2018/090998, filed on Jun. 13, 2018.

(30) Foreign Application Priority Data
Oct. 31, 2017 (CN) 201721426915.4

(51) Int. Cl. G09G 3/3258; G09G 3/3233

(52) U.S. Cl. CPC G09G 3/3258; G09G 2300/0809; G09G 2320/0233; G09G 3/3233

(57) ABSTRACT

The disclosure discloses a pixel circuit and a driving method thereof, a display device. The pixel circuit includes a first thin film transistor, a second thin film transistor, a third thin film transistor, a fourth thin film transistor, a fifth thin film transistor, a sixth thin film transistor, a seventh thin film transistor, an eighth thin film transistor, a light-emitting diode, a storage capacitor and a compensation module.

### FIELD OF THE DISCLOSURE

Exemplary embodiments of the disclosure relate to the field of display technology, and more particularly to pixel circuits and driving methods thereof, display devices.

### BACKGROUND

An organic light-emitting display device is a display device in which an organic light-emitting diode is used as a light-emitting component, and has characteristics of high contrast, thin thickness, wide viewing angle, fast response speed, low power consumption, etc., and is increasingly applied to various fields of display and illumination.

In existing organic light-emitting display devices, a plurality of pixel circuits may be generally included. The plurality of pixel circuits are generally supplied with power supply voltages from a same power supply. The power supply voltage can determine a current flowing through the light-emitting diode in the pixel circuit.

However, in practical applications, when the power supply voltage is transmitted between the plurality of pixel circuits, an power supply voltage drop (IR drop) is inevitably generated, resulting in different actual power supply voltages acting on each pixel circuit, and further resulting in different currents flowing through each light-emitting diode and uneven display luminance of the display device.

### SUMMARY

The main purpose of the disclosure is to provide pixel circuits and driving methods thereof, display devices, which aim at solving the problem of the uneven display luminance of a display device due to different currents flowing through light-emitting diodes caused by a power supply voltage drop.

In order to achieve the above purpose, a pixel circuit provided by an exemplary embodiment of the disclosure comprises a first thin film transistor, a second thin film transistor, a third thin film transistor, a fourth thin film transistor, a fifth thin film transistor, a sixth thin film transistor, a seventh thin film transistor, an eighth thin film transistor, a light-emitting diode, a storage capacitor and a compensation module,

a gate of the first thin film transistor being separately connected to a source of the third thin film transistor, a source of the fourth thin film transistor and a first end of the storage capacitor, a drain of the fourth thin film transistor being separately connected to a drain of the eighth thin film transistor and a reference voltage signal line, a second end of the storage capacitor being separately connected to a drain of the seventh thin film transistor and an output terminal of the compensation module, and an input terminal of the compensation module is connected to a compensation voltage signal line;

a source of the first thin film transistor being separately connected to a drain of the second thin film transistor, a drain of the fifth thin film transistor and a source of the seventh thin film transistor, a source of the second thin film transistor being connected to a data voltage signal line, and a source of the fifth thin film transistor being connected to a first power supply;

a drain of the first thin film transistor being separately connected to a drain of the third thin film transistor and a source of the sixth thin film transistor, a drain of the sixth thin film transistor being separately connected to a source of the eighth thin film transistor and an anode of the light-emitting diode, and a cathode of the light-emitting diode being connected to a second power supply.

Optionally, the compensation module provides a compensation voltage, and the compensation module controls the compensation voltage to apply the compensation voltage to the gate of the first thin film transistor via the storage capacitor, and compensates for a power supply voltage provided by the first power supply, to make the voltage flowing through the light-emitting diode independent of the first power supply.

Optionally, the compensation voltage is a positive voltage and the compensation voltage is greater than the power supply voltage provided by the first power supply; or,

the compensation voltage is a negative voltage, and the compensation voltage and a reference voltage provided by the reference signal line are provided by a same power supply.

Optionally, the first power supply provides the power supply voltage for the first thin film transistor;

a current flows into the second power supply when the light-emitting diode emits light.

Optionally, the reference voltage signal line provides the reference voltage, and the reference voltage is a negative voltage and initializes the gate of the first thin film transistor and the anode of the light-emitting diode.

Optionally, the reference voltage is less than the voltage of the second power supply.

Optionally, a gate of the fourth thin film transistor is connected to a first scan line, and a first scan signal provided by the first scan line controls the fourth thin film transistor to make it in an on-state, and initializes the gate of the first thin film transistor;

a gate of the second thin film transistor and a gate of the third thin film transistor are connected to a second scan line, and a second scan signal provided by the second scan line controls the second thin film transistor and the third thin film transistor to make them in the on-state, and compensates for a threshold voltage of the first thin film transistor;

a gate of the eighth thin film transistor is connected to a third scan line, and a third scan signal provided by the third scan line controls the eighth thin film transistor to make it in the on-state, and initializes the anode of the light-emitting diode;

a gate of the fifth thin film transistor, a gate of the sixth thin film transistor, and a gate of the seventh thin film transistor are connected to a light-emitting control line, and a light-emitting control signal provided by the light-emitting control line controls the fifth thin film transistor, the sixth thin film transistor, and the seventh thin film transistor to make them in the on-state, and the current flows through the light-emitting diode, and the first power supply is connected to the second end of the storage capacitor, the first power supply applies a voltage to the second end of the storage capacitor, and under the action of the storage capacitor, the current flowing through the light-emitting diode is related to the compensation voltage and independent of the first power supply.

Optionally, the first thin film transistor, the second thin film transistor, the third thin film transistor, the fourth thin film transistor, the fifth thin film transistor, the sixth thin film transistor, the seventh thin film transistor and the eighth thin film transistor are all P-type thin film transistors.

Optionally, the first thin film transistor is a P-type thin film transistor, and the second thin film transistor, the third thin film transistor, the fourth thin film transistor, the fifth thin film transistor, the sixth thin film transistor, the seventh thin film transistor and the eighth thin film transistor are all N-type thin film transistors.

Optionally, the first thin film transistor is a P-type thin film transistor, and there are P-type thin film transistors and N-type thin film transistors in the second thin film transistor, the third thin film transistor, the fourth thin film transistor, the fifth thin film transistor, the sixth thin film transistor, the seventh thin film transistor and the eighth thin film transistor.

Optionally, the compensation module comprises a compensation voltage signal line and an ninth thin film transistor,

the compensation voltage signal line provides the compensation voltage;

a source of the ninth thin film transistor is connected to the compensation voltage signal line, a drain of the ninth thin film transistor is separately connected to the drain of the seventh thin film transistor and the second end of the storage capacitor, and a gate of the ninth thin film transistor is connected to a fourth scan line.

Optionally, when a fourth scan signal provided by the fourth scan line controls the ninth thin film transistor to make it in the on-state, the compensation voltage signal line is connected to the second end of the first capacitance, and the compensation voltage signal line applies a voltage to the storage capacitor.

An exemplary embodiment of the disclosure provides a driving method of a pixel circuit, and the driving method is used to drive the above-recorded pixel circuits, and the driving method comprises:

in a first stage, controlling the fourth thin film transistor to change it from an off-state to an on-state by the first scan signal, and initializing the gate of the first thin film transistor and the first end of the storage capacitor by the reference voltage, controlling the second thin film transistor and the third thin film transistor to make them in the off-state by the second scan signal, controlling the eighth thin film transistor to make it in the off-state by the third scan signal, and controlling the fifth thin film transistor, the sixth thin film transistor and the seventh thin film transistor to make them in the off-state by the light-emitting control signal;

in a second stage, controlling the fourth thin film transistor to change it from the on-state to the off-state by the first scan signal, controlling the second thin film transistor and the third thin film transistor to change them from the off-state to the on-state by the second scan signal and compensating for the threshold voltage of the first thin film transistor, controlling the eighth thin film transistor to change it from the off-state to the on-state by the third scan signal and initializing the anode of the light-emitting diode, controlling the fifth thin film transistor, the sixth thin film transistor and the seventh thin film transistor to make them in the off-state by the light-emitting control signals, and applying the compensation voltage to the second end of the storage capacitor by the compensation module;

in a third stage, controlling the fourth thin film transistor to make it in the off-state by the first scan signal, and controlling the second thin film transistor and the third thin film transistor to change them from the on-state to the off-state by the second scan signal, controlling the eighth thin film transistor to change it from the on-state to the off-state by the third scan signal, controlling the fifth thin film transistor, the sixth thin film transistor and the seventh thin film transistor to change them from the off-state to the on-state by the light-emitting control signal, and emitting light by the light-emitting diode.

Optionally, in the third stage, the compensation voltage compensates for the first power supply, and the current flowing through the light-emitting diode is independent of the first power supply.

An exemplary embodiment of the disclosure also provides a display device, including the pixel circuit recorded above.

The following beneficial effects can be achieved by at least one of the above technical solutions adopted by the exemplary embodiments of the disclosure:

The pixel circuit provided by the exemplary embodiments of the disclosure includes the compensation module which can compensate for a power supply voltage acting on the pixel circuit during a light-emitting stage of the pixel circuit, so that the current flowing through the light-emitting diode is independent of the power supply voltage, thereby avoiding the problem of the uneven display of the display device due to different currents flowing through the light-emitting diodes caused by a power supply voltage drop.

In addition, the pixel circuit provided by the exemplary embodiments of the disclosure can also achieve compensation for the threshold voltage of a drive thin film transistor, thereby effectively avoiding the problem of the uneven display of the display device due to different threshold voltages of drive thin film transistors.

### BRIEF DESCRIPTION OF THE DRAWINGS

FIG. 1 is a schematic structural diagram of a pixel circuit in the prior art;

FIG. 2 is a schematic structural diagram of a pixel circuit provided by an exemplary embodiment of the disclosure;

FIG. 3 is a schematic structural diagram of another pixel circuit provided by an exemplary embodiment of the disclosure;

FIG. 4 is a timing diagram of a method for driving a pixel circuit provided by an exemplary embodiment of the disclosure.

### DETAILED DESCRIPTION OF PREFERRED EXEMPLARY EMBODIMENTS

In the existing organic light-emitting display devices, a plurality of pixel circuits may be generally included. The plurality of pixel circuits are generally supplied with power supply voltages from the same power source. The power supply voltage can determine a current flowing through the light-emitting diode in the pixel circuit. However, in practical applications, when the power supply voltage is transmitted between the plurality of pixel circuits, an power supply voltage drop is inevitably generated, resulting in different actual power supply voltages acting on each pixel circuit, and further resulting in different currents flowing through each light-emitting diode and uneven display luminance of the display device

FIG. 1 is a schematic structural view of a pixel circuit included in the existing display device. As shown in FIG. 1, in a light-emitting stage of the pixel circuit, a current flowing through a light-emitting diode D1 is determined by a power supply voltage supplied by a power supply VDD, wherein the larger the power supply voltage provided by the power supply VDD is, the larger the current flowing through the light-emitting diode D1 is, and the higher the luminance of the display device is.

However, when the power supply voltage provided by the power supply VDD generates a power supply voltage drop, the actual power supply voltage acting on each pixel circuit in the display device is different, resulting in different currents flowing through the light-emitting diodes D1 and uneven display luminance of the display device.

In recent years, with the rapid development of display technology, the resolution of the display device gets higher and higher, and a high requirement for the luminance of the display devices also gets higher and higher, so that the current in the display device is relatively large. For the power supply voltage, since the power supply voltage simultaneously serves to provide the drive current of the pixel circuit and the current flowing through the light-emitting diode, the current generated by the power supply voltage is relatively large, so that the power supply voltage drop generated by the power supply voltage during transmission will be increased, resulting in a greater difference in the currents flowing through the light-emitting diodes in the pixel circuit shown in FIG. 1, and making the uneven display of the display device more evident.

As can be seen, it is necessary to provide a pixel circuit which can avoid the influence of the power supply voltage on the uneven display of the display device in the pixel circuit shown in FIG. 1.

In order to solve the above problem present in the prior art, exemplary embodiments of the disclosure provide pixel circuits and driving methods thereof, display devices, which improves the circuit structure of the pixel circuit shown in FIG. 1 and adds a compensation module. The compensation module can compensate for a power supply voltage acting on the pixel circuit during a light-emitting stage of the pixel circuit, so that the current flowing through the light-emitting diode is independent of the power supply voltage, thereby avoiding the problem of the uneven display of the display device due to different currents flowing through light-emitting diodes caused by the power supply voltage drop.

The technical solutions of the disclosure are clearly and completely described below in conjunction with the specific exemplary embodiments of the disclosure and the corresponding drawings.

It should be noted that, in the pixel circuit provided by the exemplary embodiments of the disclosure, a first thin film transistor is a drive thin film transistor, specifically, a P-type thin film transistor; a second thin film transistor, a third thin film transistor, a fourth thin film transistor, a fifth thin film transistor, a sixth thin film transistor, a seventh thin film transistor, an eighth thin film transistor and a ninth thin film transistor may all be P-type thin film transistors or N-type thin film transistors, and at least one of them may also be a P-type thin film transistor and the remaining ones may be N-type thin film transistors, which are not specifically limited in the exemplary embodiments of the disclosure.

The light-emitting diode may be an LED or an OLED, and is not specifically limited herein.

Technical solutions provided by the exemplary embodiments of the disclosure are described in detail below in conjunction with the accompanying drawings.

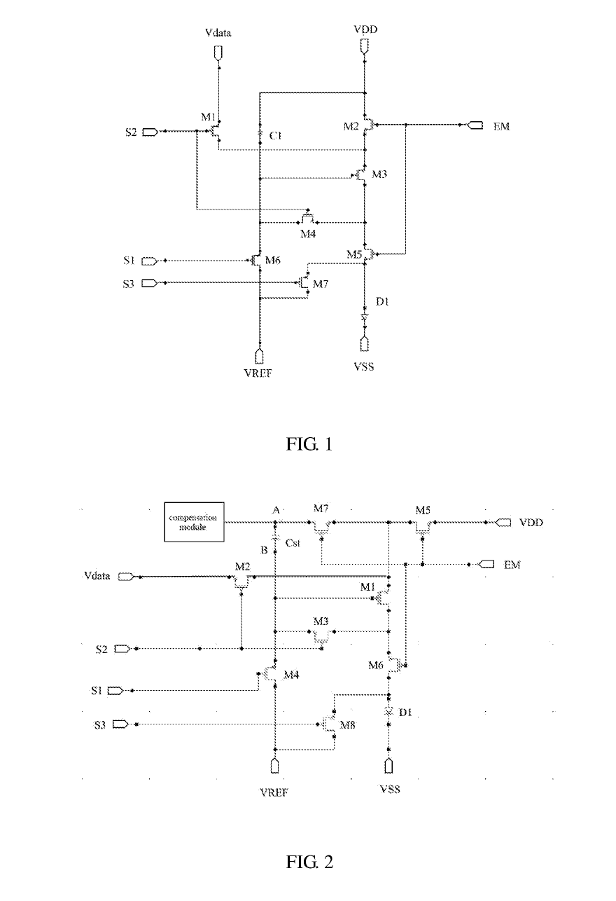

FIG. 2 is a schematic structural diagram of a pixel circuit provided by an exemplary embodiment of the disclosure. The pixel circuit is as follows.

As shown in FIG. 2, the pixel circuit includes a first thin film transistor M1, a second thin film transistor M2, a third thin film transistor M3, a fourth thin film transistor M4, a fifth thin film transistor M5, a sixth thin film transistor M6, a seventh thin film transistor M7, an eighth thin film transistor M8, a storage capacitor Cst, a light-emitting diode D1 and a compensation module.

Wherein, in the pixel circuit shown in FIG. 2, the first thin film transistor M1, the second thin film transistor M2, the third thin film transistor M3, the fourth thin film transistor M4, the fifth thin film transistor M5, the sixth thin film transistor M6, the seventh thin film transistor M7 and eighth thin film transistor M8 are all a P-type thin film transistor, and the light-emitting diode D1 is an OLED.

The circuit connection structure of the pixel circuit shown in FIG. 2 is as follows:

A gate of the first thin film transistor M1 is separately connected to a source of the third thin film transistor M3, a source of the fourth thin film transistor M4 and an end of the storage capacitor Cst (the point B shown in FIG. 2), a source of the first thin film transistor M1 is separately connected to a drain of the second thin film transistor M2, a drain of the fifth thin film transistor M5 and a source of the seventh thin film transistor M7; and a drain of the first thin film transistor M1 is separately connected to a drain of the third thin film transistor M3 and a source of the sixth thin film transistor M6;

a source of the second thin film transistor M2 is connected to a data voltage signal line;

a drain of the fourth thin film transistor M4 is separately connected to a drain of the eighth thin film transistor M8 and a reference voltage signal line;

a source of the fifth thin film transistor M5 is connected to a first power supply VDD;

a drain of the sixth thin film transistor M6 is separately connected to a source of the eighth thin film transistor M8 and an anode of the light-emitting diode D1;

a drain of the seventh thin film transistor M7 is connected to the other end of the storage capacitor Cst (the point A shown in FIG. 2);

a cathode of the light-emitting diode D1 is connected to a second power supply VSS;

an output end of the compensation module is separately connected to the drain of the seventh thin film transistor M7 and the other end of the storage capacitor Cst (the point A shown in FIG. 2).

It should be noted that, in practical applications, the third thin film transistor M3 shown in FIG. 1 may be replaced with two common-gate thin film transistors, so that during the operation of the pixel circuit, the two common-gate thin film transistors can reduce the leakage current of the branch at which the third thin film transistor M3 is located. Similarly, the fourth thin film transistor M4 can also be replaced with the two common-gate thin film transistors to reduce the leakage current of the branch at which the fourth thin film transistor M4 is located. In addition, as for other thin film transistors in FIG. 1 which can be regarded as a switching transistor, one or more thin film transistors can be replaced with the two common-gate thin film transistors according to actual requirements, so as to reduce the leakage current of the branch at which it is located, which is not specifically limited in the exemplary embodiment of the disclosure.

In the exemplary embodiment of the disclosure, the first power supply VDD may be a positive voltage and is used to provide a supply voltage for the first thin film transistor M1. The first thin film transistor M1 may output a current under the action of the first power supply VDD. The current flows into the light-emitting diode D1 to make the light-emitting diode D1 emit light. When the light-emitting diode D1 emits the light, the current flows into the second power supply VSS. The second power supply VSS may be a negative voltage.

The data voltage signal line can be used to provide a data voltage Vdata. The reference voltage signal line can be used to provide a reference voltage VREF. In the exemplary embodiment of the disclosure, the reference voltage VREF may be a negative voltage and be used to initialize the gate of the first thin film transistor M1 and the anode of the light-emitting diode D1, wherein the reference voltage VREF may be a negative voltage lower than the second power supply VSS, such that when the reference voltage VREF initializes the anode of the light-emitting diode D1, it is ensured that the light-emitting diode D1 does not emit light.

In the exemplary embodiment of the disclosure, the compensation module can provide a compensation voltage, and the compensation module may control the compensation voltage to apply a voltage to the gate of the first thin film transistor M1 via the storage capacitor Cst, such that the compensation voltage may compensate for the power supply voltage provided by the first power supply VDD during operation of the pixel circuit, thereby making the current flowing through the light-emitting diode D1 independent of the first power supply VDD.

It should be noted that, in the exemplary embodiment of the disclosure, the compensation voltage may be the positive voltage or negative voltage. Wherein, when the compensation voltage is the positive voltage, the compensation voltage may be greater than the first power supply VDD; when the compensation voltage is the negative voltage, the compensation voltage and the reference voltage VREF may be provided by the same power supply. At this time, the data voltage Vdata may be the negative voltage and smaller than the compensation voltage.

In the pixel circuit shown in FIG. 2, S1 is a first scan signal provided by a first scan line, S2 is a second scan signal provided by a second scan line, S3 is a third scan signal provided by a third scan line and EM is a light-emitting control signal provided by a light-emitting control line, wherein:

a gate of the fourth thin film transistor M4 is connected to the first scan line, and the first scan signal S1 provided by the first scan line can control the fourth thin film transistor M4 to make it in an on-state or an off-state;

a gate of the second thin film transistor M2 and a gate of the third thin film transistor M3 are connected to the second scan line, and the second scan signal S2 provided by the second scan line can control the second thin film transistor M2 and the third thin film transistor M3 to make them in the on-state or off-state;

a gate of the eighth thin film transistor M8 is connected to the third scan line, and the third scan signal S3 provided by the second scan line can control the eighth thin film transistor M8 to make it in the on-state or off-state;

a gate of the fifth thin film transistor M5, a gate of the sixth thin film transistor M6 and a gate of the seventh thin film transistor M7 are connected to the light-emitting control line, and the light-emitting control signal EM provided by the light-emitting control line can control the fifth film transistor M5, the sixth thin film transistor M6, and the seventh thin film transistor M7 to make them in the on-state or off-state.

In the exemplary embodiment of the disclosure, when the first scan signal S1 controls the fourth thin film transistor M4 to make it in the on-state, the reference voltage VREF may apply a voltage to the gate of the first thin film transistor M1 via the fourth thin film transistor M4 and initialize the gate of the first thin film transistor M1;

when the second scan signal S2 controls the second thin film transistor M2 and the third thin film transistor M3 to make them in the on-state, as for the first thin film transistor M1, the gate and the drain of the first thin film transistor M1 are connected to each other, and the data voltage Vdata applies a voltage to the source of the first thin film transistor M1 via the second thin film transistor M2. After the state of the circuit is stabilized, a source voltage of the first thin film transistor M1 is Vdata, and a gate voltage and a drain voltage are both Vdata−Vth, thereby achieving the compensation for a threshold voltage of the first thin film transistor M1, wherein Vth is the threshold voltage of the first thin film transistor M1;

when the third scan signal S3 controls the eighth thin film transistor M8 to make it in the on-state, the reference voltage VREF may apply a voltage to the anode of the light-emitting diode D1 via the eighth thin film transistor M8 and initializes the anode of the light-emitting diode D1;

when the light-emitting control signal EM controls the fifth thin film transistor M5, the sixth thin film transistor M6 and the seventh thin film transistor M7 to make them in the on-state, the first power supply VDD may apply a voltage to the source of the first thin film transistor M1 via the fifth thin film transistor M5. The first thin film transistor M1 can generate a current which flows through the light-emitting diode D1 to make the light-emitting diode D1 emit light.

In addition, when the light-emitting control signal EM controls the fifth thin film transistor M5 and the seventh thin film transistor M7 to make them in the on-state, the first power supply VDD may also be connected to the other end of the storage capacitor Cst (the point A shown in FIG. 2). At this time, the compensation module may control the compensation voltage to cut off from the storage capacitor Cst, such that the voltage of the upper plate (the point A shown in FIG. 2) of the storage capacitor Cst is changed from the compensation voltage to VDD. Therefore, the action of the storage capacitor Cst can cause the current flowing through the light-emitting diode D1 to be related to the compensation voltage VIN and independent of the first power supply VDD, thereby achieving the compensation for the first power supply VDD, and can cause the power supply voltage drop generated by the first power supply VDD not to influence on the current flowing through the light-emitting diode D1, thereby ensuring the display evenness of the display device.

In another exemplary embodiment provided by the disclosure, the compensation module may include a compensation voltage signal line and a ninth thin film transistor, and the ninth thin film transistor may be a P-type thin film transistor or a N-type thin film transistor.

Wherein the compensation voltage signal line may be used to provide a compensation voltage, and a source of the ninth thin film transistor is connected to the compensation voltage signal line, a drain thereof is connected to the drain of the seventh thin film transistor and the other end of the storage capacitor, and a gate thereof is connected to a fourth scan line.

In the exemplary embodiment of the disclosure, a fourth scan signal provided by the fourth scan line may be the same as the second scan signal provided by the second scan line described in the exemplary embodiment shown in FIG. 2. In order to save a space, the four scan line and the second scan line may be the same scan line. The following is described by replacing the fourth scan line with the second scan line.

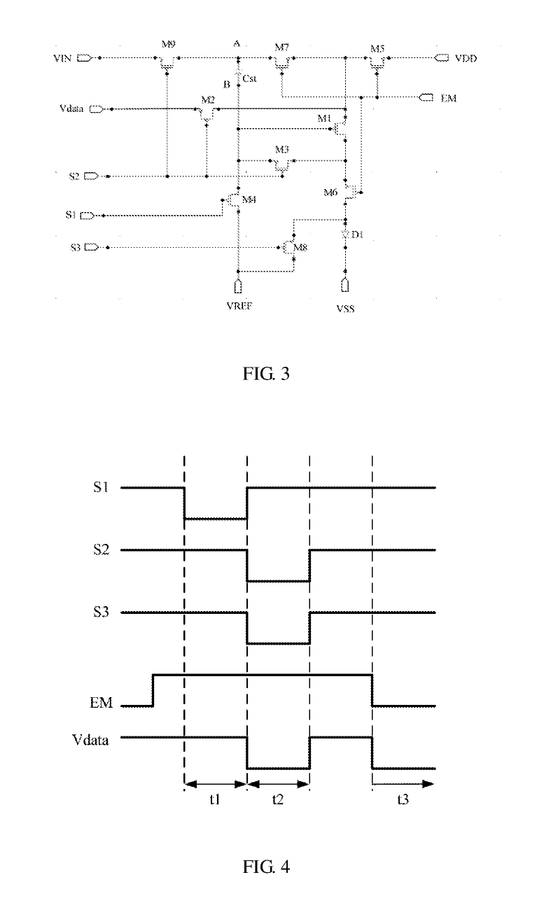

FIG. 3 is a schematic structural diagram of another pixel circuit provided by an exemplary embodiment of the disclosure. Wherein in comparison with FIG. 2, in FIG. 3, the compensation module shown in FIG. 2 is replaced with the compensation voltage signal line and the ninth thin film transistor M9.

In FIG. 3, VIN is the compensation voltage provided by the compensation voltage signal line, and the ninth thin film transistor M9 is the P-type thin film transistor, wherein the source of the ninth thin film transistor M9 is connected to the compensation voltage signal line, the drain thereof is separately connected to the drain of the seventh thin film transistor M7 and the other end of the storage capacitor Cst (the point A shown in FIG. 3), and the gate thereof is connected to the second scan line.

In the pixel circuit shown in FIG. 3, the second scan line S2 can control the ninth thin film transistor M9 to make it in the on-state or off-state. When the second scan line S2 controls the ninth thin film transistor M9 to make it in the on-state, a voltage can be applied to the upper plate of the storage capacitor Cst (the point A shown in FIG. 3) by the compensation voltage VIN, such that the voltage of the upper plate of the storage capacitor Cst is VIN.

Thus, when the light-emitting control signal EM controls the fifth thin film transistor M5 and the seventh thin film transistor M7 to make them in the on-state, the first power supply VDD is connected to the other end of the storage capacitor Cst (the point A shown in FIG. 3) and the first power supply VDD applies a voltage to the upper plate of the storage capacitor Cst, so that the voltage of the upper plate of the storage capacitor Cst is changed from VIN to VDD. Therefore, the current flowing through the light-emitting D1 is related to the compensation voltage VIN and independent of the first power supply VDD under the action of the storage capacitor Cst, thereby achieving the compensation for the first power supply VDD, such that the power supply voltage drop generated by the first power supply VDD does not influence on the current flowing through the light-emitting D1, ensuring display evenness of the display device.

FIG. 4 is a timing diagram of a driving method for a pixel circuit provided by an exemplary embodiment of the disclosure. The driving method of the pixel circuit may be used to drive the pixel circuit shown in FIG. 2 or FIG. 3. The following will be described by taking the pixel circuit shown in FIG. 3 for example.

When the timing diagram shown in FIG. 4 drives the pixel circuit shown in FIG. 3, the working cycle may include three stages: a first stage t1, a second stage t2, and a third stage t3. Wherein, S1 is the first scan signal provided by the first scan line and can be used to control the fourth thin film transistor M4 shown in FIG. 3 to make it in the on-state or off-state, S2 is the second scan signal provided by the second scan line and can be used to control the second thin film transistor M2, the third thin film transistor M3 and the ninth thin film transistor M9 shown in FIG. 3 to make them in the on-state or off-state, S3 is the third scan signal provided by the third scan line and can be used to control the eighth thin film transistor M8 shown in FIG. 3 to make it in the on-state or off-state, EM is the light-emitting control signal provided by the light-emitting control line and can be used to control the fifth thin film transistor M5, the sixth thin film transistor M6 and the seventh thin film transistor M7 shown in FIG. 3 to make them in the on-state or off-state, and Vdata is the data voltage provided by the data voltage signal line.

The following explains the above three stages separately:

For the first stage t1:

Since the first scan signal S1 changes from a high level to a low level, the second scan signal S2 maintains at the high level, the third scan signal S3 maintains at the high level and the light-emitting control signal EM changes from the low level to the high level, the fourth thin film transistor M4 is in the on-state, the second thin film transistor M2, the third thin film transistor M3 and the ninth thin film transistor M9 are in the off-state, the eighth thin film transistor M8 is in the off-state and the fifth thin film transistor M5, the sixth thin film transistor M6 and the seventh thin film transistor M7 are in the off-state.

At this time, the reference voltage VREF applies a voltage to the gate of the first thin film transistor M1 and the lower plate of the storage capacitor Cst (the point B shown in FIG. 3) via the fourth thin film transistor M4 and initializes the gate of the first thin film transistor M1 and the lower plate of the storage capacitor Cst.

After initialization, the gate voltage of the first thin film transistor M1 is equal to VREF, and the voltage of the lower plate of the storage capacitor Cst is also VREF.

For the second stage t2:

Since the first scan signal S1 changes from the low level to the high level, the second scan signal S2 changes from the high level to the low level, the third scan signal S3 changes from the high level to the low level and the light-emitting control signal EM remains at the high level, the fourth thin film transistor M4 changes from the on-state to the off-state, and the second thin film transistor M2, the third thin film transistor M3 and the ninth thin film transistor M9 change from the off-state to the on-state, the eighth thin film transistor M8 changes from the off-state to the on-state, and the fifth thin film transistor M5, the sixth thin film transistor M6 and the seventh thin film transistor M7 are still in the off-state.

At this time, the gate of the first thin film transistor M1 is connected to the drain thereof, and the data voltage Vdata applies a voltage to the source of the first thin film transistor M1 via the second thin film transistor M2. At this time, the source voltage of the first thin film transistor M1 is Vdata. Since the gate voltage of the first thin film transistor M1 is VREF in the first stage t1, the first thin film transistor M1 is in the on-state. The data voltage Vdata acts on the gate of the first thin film transistor M1 via the first thin film transistor M1 and the third thin film transistor M3, finally making both the gate voltage of and the drain voltage of the first thin film transistor M1 to be Vdata−Vth and making the first thin film transistor M1 in the off-state, thereby achieving the compensation for the threshold voltage of the first thin film transistor M1, wherein Vth is the threshold voltage of the first thin film transistor M1.

The compensation voltage VIN applies a voltage to the upper plate of the storage capacitor Cst via the ninth thin film transistor M9 so that the voltage of the upper plate of the storage capacitor Cst becomes VIN. At this time, since the voltage of the lower plate of the storage capacitor Cst is equal to the gate voltage of the first thin film transistor M1, the voltage of the lower plate of the storage capacitor Cst is Vdata−Vth, and voltage difference between the lower plate and the upper plate of the storage capacitor Cst is Vdata−Vth-VIN.

Further, the reference voltage VREF applies a voltage to the anode of the light-emitting diode D1 via the eighth thin film transistor M8, and initializes the anode of the light-emitting diode D1, so that the light-emitting diode D1 does not emit light. In this way, the pixel circuit can be made to display pure black in the second stage t2, thereby increasing the display contrast of the entire display device.

For the third stage t3:

Since the first scan signal S1 remains at the high level, the second scan signal S2 changes from the low level to the high level, the third scan signal S3 changes from the low level to the high level and the light-emitting control signal EM changes from the high level to the low level, the fourth thin film transistor M4 is still in the off-state, and the second thin film transistor M2, the third thin film transistor M3 and the ninth thin film transistor M9 change from the on-state to the off-state, the eighth thin film transistor M8 changes from the on-state to the off-state and the fifth thin film transistor M5, the sixth thin film transistor M6 and the seventh thin film transistor M7 change from the off-state to the on-state.

At this time, the first power supply VDD applies a voltage to the upper plate of the storage capacitor Cst via the fifth thin film transistor M5 and the seventh thin film transistor M7, so that the voltage of the upper plate of the storage capacitor Cst becomes VDD. Due to the coupling effect of the storage capacitor Cst at this time, the voltage difference between the lower plate and the upper plate of the storage capacitor Cst keep unchanged, and the voltage of the lower plate of the storage capacitor Cst is VDD+Vdata−Vth−VIN. Since the gate voltage of the first thin film transistor M1 is equal to the voltage of the lower plate of the storage capacitor Cst, the gate voltage of the first thin film transistor M1 is VDD+Vdata−Vth−VIN.

The first power supply VDD applies a voltage to the source of the first thin film transistor M1 via the fifth thin film transistor M5 so that the source voltage of the first thin film transistor M1 is VDD, the first thin film transistor M1 is turned on, the current flows through the light-emitting diode D1, and the light-emitting diode D1 emits light.

In the third stage t3, the current flowing through the light-emitting diode D1 can be expressed as:

$${I}_{OLED} = μ {C}_{ox} \frac{W}{2 L} {( {V}_{gs} - Vth )}^{2} = μ {C}_{ox} \frac{W}{2 L} {( {V}_{s} - {V}_{g} - Vth )}^{2} = μ {C}_{ox} \frac{W}{2 L} {( VIN - Vdata )}^{2}$$

Wherein, μ is the electron mobility of the first thin film transistor M1, Cox is the gate oxide layer capacitance per unit area of the first thin film transistor M1 and W/L is the aspect ratio of the first thin film transistor M1.

It can be known from the above equation that the current flowing through the light-emitting diode D1 is related to the compensation voltage VIN, and is independent of the first power supply VDD and is also independent of the threshold voltage of the first thin film transistor M1, thereby realizing the compensation for the first power supply VDD, and avoiding the influence of the power supply voltage drop of the first power supply VDD on the display effect and ensuring the display evenness of the display device, and at the same time, realizing the compensation for the threshold voltage of the first thin film transistor M1 and avoiding the problem of the uneven display of the display device due to different threshold voltages of the first thin film transistors M1.

It should be noted that in practical applications, the compensation voltage VIN also has a certain voltage drop. However, since the compensation voltage VIN only needs to charge the storage capacitor Cst and does not participate in driving the pixel circuit, the current generated by the compensation voltage VIN is much smaller than the current generated by the first power supply VDD, and the resulting voltage drop generated is also much smaller than the voltage drop generated by the first power supply VDD. That is, in the exemplary embodiment of the disclosure, the current flowing through the light-emitting diode D1 is determined by the compensation voltage VIN, effectively improving the display unevenness of the display device caused by the supply voltage.

In practical applications, a simulation is performed by using the pixel circuit provided by the exemplary embodiments of the disclosure with the compensate voltage VIN=4.6V, the data voltage Vdata=2V and the first power supply VDD=4.3/4.4/4.5/4.6/4.7/4.8V, which can obtains a simulation result: when the first power supply VDD changes, the ratio of the minimum value to the maximum value of the current flowing through the light-emitting diode D1 is about 92%, and the simulation is performed by using the pixel circuit shown in FIG. 1 with the same voltage parameter to obtain about 67% of the ratio of the minimum value to the maximum value of the current flowing through the light-emitting diode D1. As can be seen, when the first power supply VDD changes, the change in the current flowing through the light-emitting diode D1 in the pixel circuit provided by the exemplary embodiments of the disclosure is smaller than the change in the current flowing through the light-emitting diode D1 in FIG. 1. Therefore, the pixel circuit provided the exemplary embodiment of the disclosure effectively improves the display evenness of the display device.

In addition, the simulation is performed by using the pixel circuit provided by the exemplary embodiments of the disclosure with the compensation voltage VIN=4.6V, the data voltage Vdata=2V and the first power supply VDD=4.6V, which can obtains that the current generated when the storage capacitor Cst is charged by the compensation voltage VIN is about 2 pA, which is much smaller than the current 306 nA generated when the first power supply VDD acts on the first thin film transistor M1. Thus, since the current generated by the compensation voltage VIN is smaller than the current generated by the first power supply VDD, the voltage drop generated when the compensation voltage VIN is transferred from one pixel circuit to another pixel circuit is also smaller than the power supply voltage drop generated by the first power supply VDD. As can be seen, compared with the first power supply VDD, the compensation voltage VIN determines the current flowing through the light-emitting diode D1, which can effectively improve the display evenness of the display device.

The pixel circuit provided by exemplary embodiments of the disclosure includes a compensation module which can compensate for a power supply voltage acting on a drive thin film transistor during a light-emitting stage of the pixel circuit, so that a current flowing through the light-emitting diode is independent of the power supply voltage, thereby avoiding the problem of the uneven display of the display device due to different currents flowing through the light-emitting diodes caused by a power supply voltage drop.

In addition, the pixel circuit provided by the exemplary embodiments of the disclosure can also achieve compensation for the threshold voltage of a drive thin film transistor, thereby effectively avoiding the problem of the uneven display of the display device due to different threshold voltages of drive thin film transistors.

The exemplary embodiments of the disclosure further provide a display device, and the display device may include the pixel circuits described above.

What is claimed is:

1. A pixel circuit, comprising:
a first thin film transistor, a second thin film transistor, a third thin film transistor, a fourth thin film transistor, a fifth thin film transistor, a sixth thin film transistor, a seventh thin film transistor, an eighth thin film transistor, a light-emitting diode, a storage capacitor and a compensation module,
a gate of the first thin film transistor being separately connected to a source of the third thin film transistor, a source of the fourth thin film transistor and a first end of the storage capacitor, a drain of the fourth thin film transistor being separately connected to a drain of the eighth thin film transistor and a reference voltage signal line, and a second end of the storage capacitor being separately connected to a drain of the seventh thin film transistor and an output terminal of the compensation module;
a source of the first thin film transistor being separately connected to a drain of the second thin film transistor, a drain of the fifth thin film transistor and a source of the seventh thin film transistor, a source of the second thin film transistor being connected to a data voltage signal line, and a source of the fifth thin film transistor being connected to a first power supply;
a drain of the first thin film transistor being separately connected to a drain of the third thin film transistor and a source of the sixth thin film transistor, a drain of the sixth thin film transistor being separately connected to a source of the eighth thin film transistor and an anode of the light-emitting diode, and a cathode of the light-emitting diode being connected to a second power supply.

2. The pixel circuit according to claim 1, wherein, the compensation module provides a compensation voltage, and the compensation module controls the compensation voltage to apply the compensation voltage to the gate of the first thin film transistor via the storage capacitor, and compensates for a power supply voltage provided by the first power supply, to make the voltage flowing through the light-emitting diode independent of the first power supply.

3. The pixel circuit according to claim 2, wherein, the compensation voltage is a positive voltage and the compensation voltage is greater than the power supply voltage provided by the first power supply; or,
the compensation voltage is a negative voltage, and the compensation voltage and a reference voltage provided by the reference signal line are provided by a same power supply.

4. The pixel circuit according to claim 3, wherein, the first power supply provides the power supply voltage for the first thin film transistor;
a current flows into the second power supply when the light-emitting diode emits light.

5. The pixel circuit according to claim 4, wherein, the reference voltage signal line provides the reference voltage, and the reference voltage is a negative voltage and initializes the gate of the first thin film transistor and the anode of the light-emitting diode.

6. The pixel circuit according to claim 5, wherein, the reference voltage is less than the voltage of the second power supply.

7. The pixel circuit according to claim 1, wherein, a gate of the fourth thin film transistor is connected to a first scan line, and a first scan signal provided by the first scan line controls the fourth thin film transistor to make it in an on-state, and initializes the gate of the first thin film transistor;
a gate of the second thin film transistor and a gate of the third thin film transistor are connected to a second scan line, and a second scan signal provided by the second scan line controls the second thin film transistor and the third thin film transistor to make them in the on-state, and compensates for a threshold voltage of the first thin film transistor;
a gate of the eighth thin film transistor is connected to a third scan line, and a third scan signal provided by the third scan line controls the eighth thin film transistor to make it in the on-state, and initializes the anode of the light-emitting diode;
a gate of the fifth thin film transistor, a gate of the sixth thin film transistor, and a gate of the seventh thin film transistor are connected to a light-emitting control line, and a light-emitting control signal provided by the light-emitting control line controls the fifth thin film transistor, the sixth thin film transistor, and the seventh thin film transistor to make them in the on-state, and the current flows through the light-emitting diode, and the first power supply is connected to the second end of the storage capacitor, the first power supply applies a voltage to the second end of the storage capacitor, and under the action of the storage capacitor, the current flowing through the light-emitting diode is related to the compensation voltage and independent of the first power supply.

8. The pixel circuit according to claim 1, wherein, the first thin film transistor, the second thin film transistor, the third thin film transistor, the fourth thin film transistor, the fifth thin film transistor, the sixth thin film transistor, the seventh thin film transistor and the eighth thin film transistor are all P-type thin film transistors.

9. The pixel circuit according to claim 1, wherein, the first thin film transistor is a P-type thin film transistor, and the second thin film transistor, the third thin film transistor, the fourth thin film transistor, the fifth thin film transistor, the sixth thin film transistor, the seventh thin film transistor and the eighth thin film transistor are all N-type thin film transistors.

10. The pixel circuit according to claim 1, wherein, the first thin film transistor is a P-type thin film transistor, and there are P-type thin film transistors and N-type thin film transistors in the second thin film transistor, the third thin film transistor, the fourth thin film transistor, the fifth thin film transistor, the sixth thin film transistor, the seventh thin film transistor and the eighth thin film transistor.

11. The pixel circuit according to claim 1, wherein, the compensation module comprises a compensation voltage signal line and an ninth thin film transistor,
the compensation voltage signal line provides the compensation voltage;
a source of the ninth thin film transistor is connected to the compensation voltage signal line, a drain of the ninth thin film transistor is separately connected to the drain of the seventh thin film transistor and the second end of the storage capacitor, and a gate of the ninth thin film transistor is connected to a fourth scan line.

12. The pixel circuit according to claim 11, wherein, when a fourth scan signal provided by the fourth scan line controls the ninth thin film transistor to make it in the on-state, the compensation voltage signal line is connected to the second end of the first capacitance, and the compensation voltage signal line applies a voltage to the storage capacitor.

13. A driving method of a pixel circuit according to claim 1, comprising:
in a first stage, controlling the fourth thin film transistor to change it from an off-state to an on-state by the first scan signal, and initializing the gate of the first thin film transistor and the first end of the storage capacitor by the reference voltage, controlling the second thin film transistor and the third thin film transistor to make them in the off-state by the second scan signal, controlling the eighth thin film transistor to make it in the off-state by the third scan signal, and controlling the fifth thin film transistor, the sixth thin film transistor and the seventh thin film transistor to make them in the off-state by the light-emitting control signal;
in a second stage, controlling the fourth thin film transistor to change it from the on-state to the off-state by the first scan signal, controlling the second thin film transistor and the third thin film transistor to change them from the off-state to the on-state by the second scan signal and compensating for the threshold voltage of the first thin film transistor, controlling the eighth thin film transistor to change it from the off-state to the on-state by the third scan signal and initializing the anode of the light-emitting diode, controlling the fifth thin film transistor, the sixth thin film transistor and the seventh thin film transistor to make them in the off-state by the light-emitting control signals, and applying the compensation voltage to the second end of the storage capacitor by the compensation module;
in a third stage, controlling the fourth thin film transistor to make it in the off-state by the first scan signal, and controlling the second thin film transistor and the third thin film transistor to change them from the on-state to the off-state by the second scan signal, controlling the eighth thin film transistor to change it from the on-state to the off-state by the third scan signal, controlling the fifth thin film transistor, the sixth thin film transistor and the seventh thin film transistor to change them from the off-state to the on-state by the light-emitting control signal, and emitting light by the light-emitting diode.

14. The driving method according to claim 13, wherein, in the third stage, the compensation voltage compensates for the first power supply, and the current flowing through the light-emitting diode is independent of the first power supply.

15. A display device, comprising a pixel circuit according to claim 1.
